(19) United States
(12) Patent Application Publication
(10) Pub. No.: US 2012/0262429 A1
(43) Pub. Date: Oct. 18, 2012

(54) PEN FOR CAPACITIVE TOUCH INPUT

(75) Inventors: Ta-Fan Hsu, New Taipei City (TW); Shu-Wei Huang, Taipei City (TW)

(73) Assignee: Elan Microelectronics Corporation, Hsinchu (TW)

(21) Appl. No.: 13/445,443

(22) Filed: Apr. 12, 2012

(30) Foreign Application Priority Data
Apr. 13, 2011 (TW) 100112868

(51) Int. Cl. G06F 3/033; G06F 3/045

(52) U.S. Cl. 345/179

(57) ABSTRACT

A pen for capacitive touch input includes a replaceable head and a conductive handle. The conductive handle is a tube having a tunnel or a rod having a stocking hole for receiving the replaceable head and exposing the conductive tip of the replaceable head to touch a capacitive touch control device. The pen is adaptive to different capacitive touch control devices for precision and sensitivity on position detection by using different replaceable heads.

### FIELD OF THE INVENTION

The present invention is related generally to a pen for capacitive touch input and, more particularly, to a pen-like structure for operation on a capacitive touch control device.

### BACKGROUND OF THE INVENTION

Conventional touch control devices may be classified into three types: resistive, electromagnetic and capacitive. Operation with a resistive touch control device requires a rigid pen tip to apply a significant force on the resistive touch control device in a very small area to accomplish deformation of the resistive touch sensor, and an electromagnetic touch control device requires a special battery powered pen for input; while the working principle of a capacitive touch control device relies on capacitive coupling, which takes place as soon as the capacitive touch sensor is touched by a conductive object, and the touch position can then be identified according to the variation in capacitance at the touch point. Therefore, a capacitive touch control device does not require an input pen that consumes electricity. Nor is it necessary to subject a capacitive touch sensor to concentrated pressure application for deformation, and thus a capacitive touch control device has a longer service life. Furthermore, mass production of capacitive touch control devices requires lower costs due to its simple construction, less components and higher yield rate.

A capacitive touch control device can be operated in many ways. The most common of all is using a conductor, for example a finger or a pen, to touch or slide on the surface of the capacitive touch control device, for the capacitive touch sensor thereof to generate a response signal. However, as capacitive touch control devices find more and more applications, the lower precision on position detection tends to hinder smoothness of operation where more precise and more efficient detection is required, such as in handheld devices. In order to enable enhanced precision on position detection, many people choose to use pens for capacitive touch input. There also have been many such pen structures proposed, for example, U.S. Pat. No. 4,639,720 discloses a stylus having different conductive tips at its opposite ends, respectively, for providing different line widths of input traces on a capacitive touch control device, and U.S. Pat. No. 5,488,204 discloses a conductive paintbrush stylus for a capacitive touch control device, which may reduce the pressure required by the user to apply for capacitive touch input.

As to more and more applications, a same stylus is hard to attain various precision and sensitivity of capacitive touch input to different capacitive touch control devices. Therefore, it is desired a pen-like device for operation with different capacitive touch control devices.

### SUMMARY OF THE INVENTION

An objective of the present invention is to provide a pen having replaceable conductive tips for capacitive touch input.

According to the present invention, a pen for capacitive touch input includes a plurality of replaceable heads and a conductive tube for receiving the replaceable heads and exposing the conductive tip of the foremost replaceable head.

According to the present invention, a pen for capacitive touch input includes a replaceable head and a conductive rod whose front end has a stocking hole for holding the replaceable head and exposing the conductive tip of the replaceable head.

### BRIEF DESCRIPTION OF THE DRAWINGS

These and other objectives, features and advantages of the present invention will become apparent to those skilled in the art upon consideration of the following description of the preferred embodiments of the present invention taken in conjunction with the accompanying drawings, in which:

FIG. 1 is an illustrative diagram of a first embodiment according to the present invention;

FIG. 2 shows a top view, a front-side view, a rear-side view and a cross-sectional view of the replaceable head in the embodiment depicted in FIG. 1;

FIG. 3 shows two replaceable heads having different conductive tips for use in the embodiment depicted in FIG. 1;

FIG. 4 is an illustrative diagram of a second embodiment according to the present invention;

FIG. 5 is an enlarged cross-sectional view of the front end of the conductive rod in the embodiment depicted in FIG. 4; and

FIG. 6 shows three replaceable heads having different conductive tips for use in the embodiment depicted in FIG. 4.

### DETAILED DESCRIPTION OF THE INVENTION

The present invention discloses a pen for capacitive touch input, which includes a replaceable head and a conductive handle combined together. The conductive handle and the replaceable head will be electrically connected to each other when they are combined together, such that when a user holds the conductive handle, the conductive tip on the replaceable head will have the same potential as that of the user's body, for the capacitive touch sensor in a capacitive touch control device may undergo significant variation in capacitance responsive to the touch of the conductive tip on the capacitive touch control device. A pen according to the present invention is adaptive to different capacitive touch control devices for precision and sensitivity on position detection by using different replaceable heads. In addition, replaceable heads having different types of conductive tips may be provided so that a user may choose a suitable one according to the desired feel of touch, the pressure to be applied when writing with the pen, and so forth. Thus, a pen according to the present invention allows different ways of operation and is convenient of use.

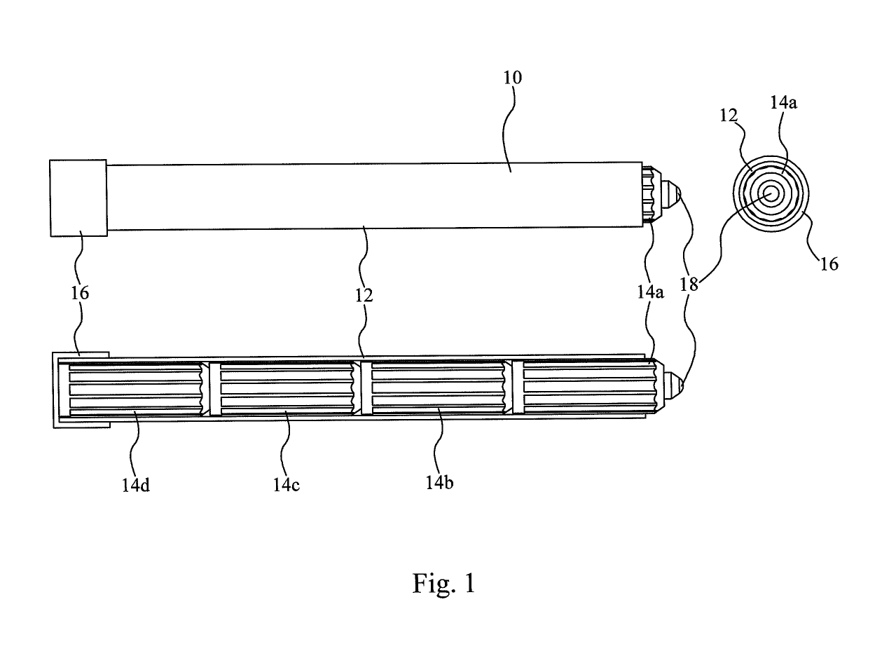

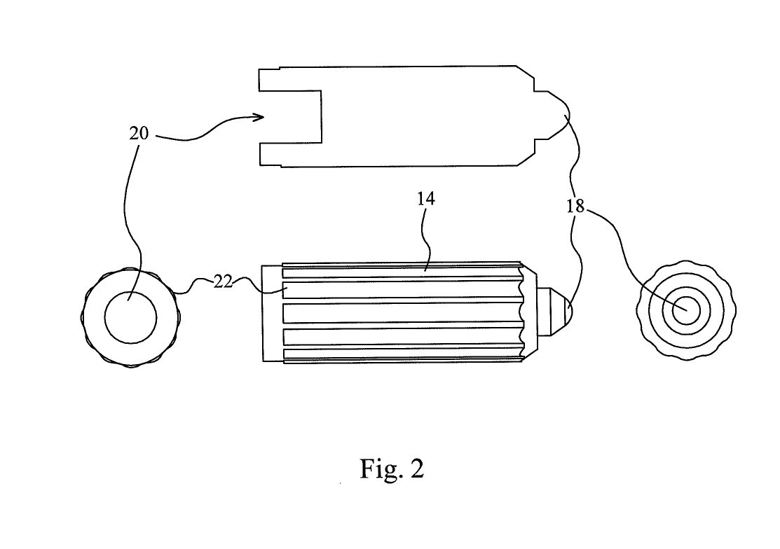

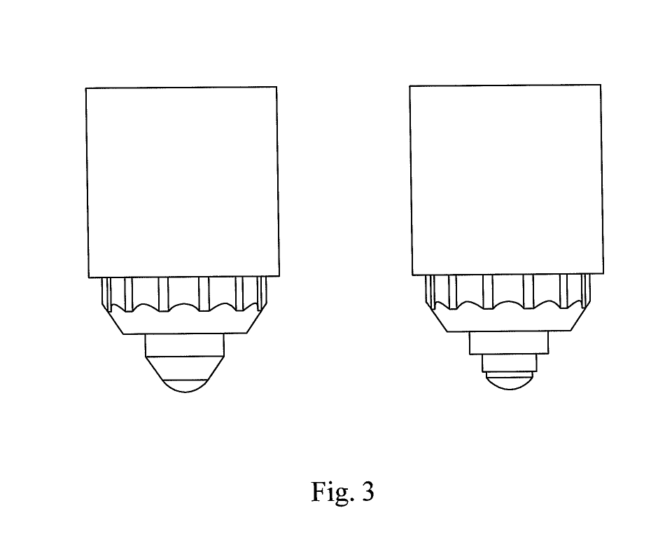

FIG. 1 is an illustrative diagram of a first embodiment according to the present invention, and FIG. 2 shows a top view, a front-side view, a rear-side view and a cross-sectional view of the replaceable head in the embodiment depicted in FIG. 1, in which a pen 10 includes a conductive tube 12, a plurality of replaceable heads 14a-14d and a tail cap 16. The conductive tube 12 is a hollow rod for receiving the replaceable heads 14a-14d and exposing the conductive tip 18 of the foremost replaceable head 14a to touch a capacitive touch control device. The structure of each of the replaceable heads 14a-14d is illustrated in FIG. 2, in which the tail end of each replaceable head 14 has a stocking hole 20 for receiving the conductive tip 18 of another replaceable head 14. In addition, each replaceable head 14 is peripherally provided with resilient projections 22 for contacting with the inner wall of the conductive tube 12. The tail cap 16 covers the tail end of the conductive tube 12 and thereby prevents the replaceable head 14d at the tail end from being pushed out of the conductive tube 12 by the pressure applied to the foremost replaceable head 14a during use. When it is desired to replace the replaceable head 14a with another one at the front end of the conductive tube 12, it can directly pull out the replaceable head 14a from the front end of the conductive tube 12, and insert the free replaceable head 14a into the tail end of the conductive tube 12, thus moving the replaceable heads 14b-14d forward in the tunnel of the conductive tube 12 until the replaceable head 14a is completely received in the conductive tube 12. Then, the tail cap 16 is put back in place. It is the conductive tip 18 of the replaceable head 14b that is now exposed for use. FIG. 3 shows two replaceable heads having different conductive tips for use in the embodiment depicted in FIG. 1.

In the embodiment shown in FIG. 1, the conductive tube 12 is made of metal or plated plastic, and the outer material of the replaceable head 14 is a rubber containing a conductive substance, for example carbon powder or metal powder. In an embodiment, the inner wall of the conductive tube 12 and the resilient projections 22 of the replaceable head 14 are electrically conductive so that the conductive tube 12 and the replaceable head 14 are electrically connected to each other in the assembled state. In another embodiment, the inner wall of the conductive tube 12 is electrically conductive only at the front end of the conductive tube 12 so that only the replaceable head 14a at the front end of the conductive tube 12 is electrically connected to the conductive tube 12.

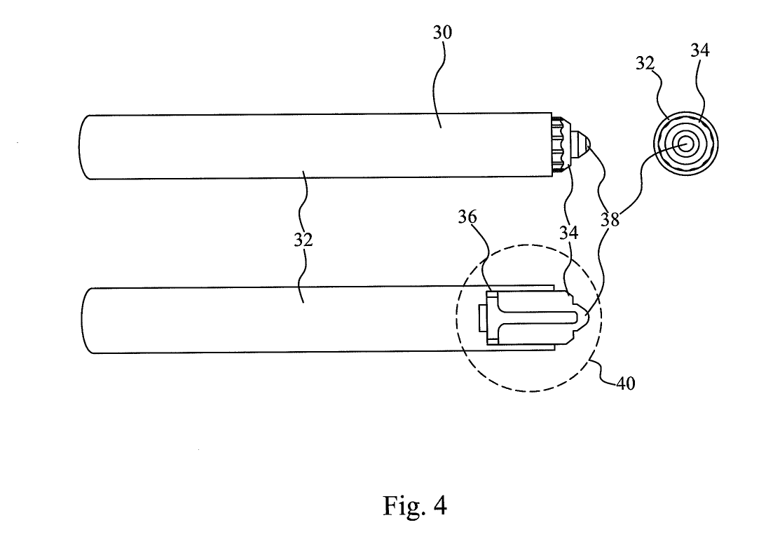

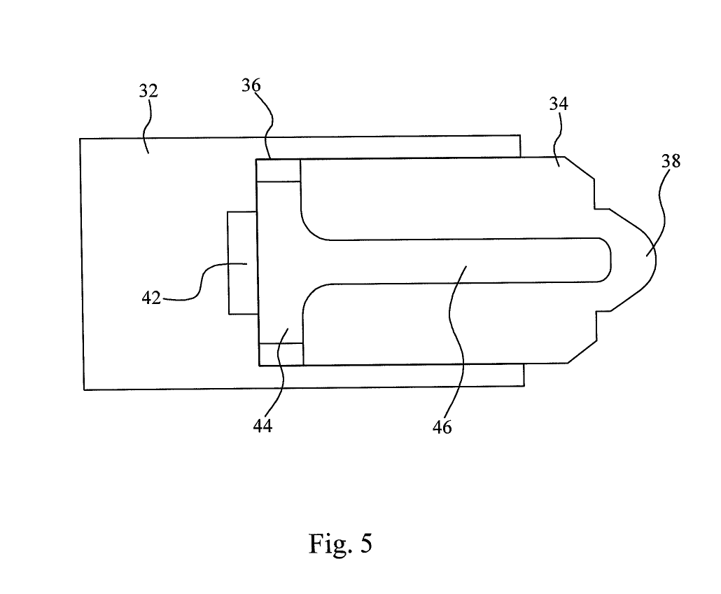

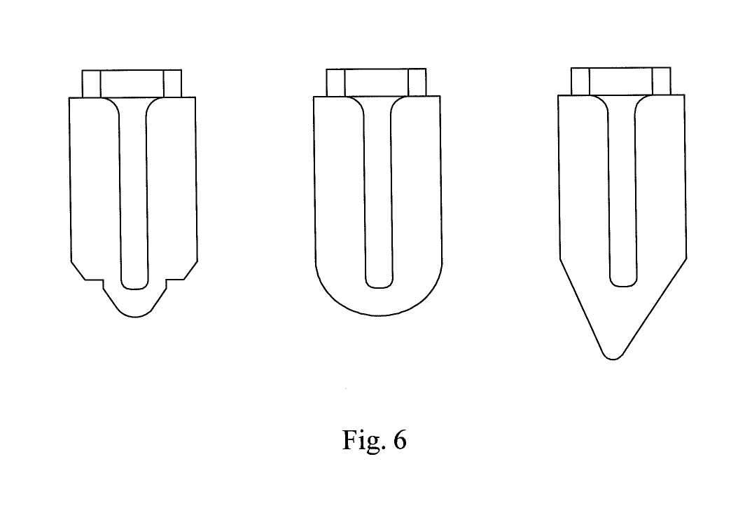

FIG. 4 is an illustrative diagram of a second embodiment according to the present invention, in which a pen 30 includes a conductive rod 32 and a replaceable head 34, and the front end of the conductive rod 32 has a stocking hole 36 for holding the replaceable head 34 and exposing the conductive tip 38 of the replaceable head 34 to touch a capacitive touch control device. FIG. 5 is an enlarged cross-sectional view of the front end 40 of the conductive tube 32 in the embodiment depicted in FIG. 4. A combination of a magnetic element and a magnetizable element is incorporated into the stocking hole 36 and the replaceable head 34 to secure the replaceable head 34 in the stocking hole 36 by magnetic attraction and thereby prevent the replaceable head 34 from falling off during use. As shown in FIG. 5, a magnetic element 42 is embedded at the bottom end of the stocking hole 36, and the tail end of the replaceable head 34 has a magnetizable element 44, which is made of metal such as iron that can be magnetized. In another embodiment, the magnetizable element is embedded at the bottom end of the stocking hole while the magnetic element is provided at the tail end of the replaceable head. Furthermore, the replaceable head 34 is peripherally provided with resilient projections as are the replaceable head 14 shown in FIG. 2. The resilient projections will be in contact with the inner wall of the stocking hole 36 to assist in securing the replaceable head 34. FIG. 6 shows three replaceable heads having different conductive tips for use in the embodiment depicted in FIG. 4. From the foregoing embodiments, it would be understood that a replaceable head can be secured in the stocking hole of a conductive rod by magnetic force or by resilient projections no matter what kind of detailed mechanical structure is designed.

In the embodiment shown in FIG. 4, the conductive rod 32 is made of metal or plated plastic, and the replaceable head 34 to be in contact with a touch pad or touch screen is covered with a rubber portion that contains a conductive substance, for example carbon powder or metal powder. As shown in FIG. 5, the replaceable head 34 has a central post 46, which is combined with the rubber portion containing the conductive substance by a co-molding process to increase the bonding between the central post 46 and the rubber portion. In another embodiment, the magnetizable element 44 and the central post 46 are made of a same material or are two parts of a same component. In an embodiment, the inner wall of the stocking hole 36 is electrically conductive to enable electrical connection between the conductive rod 32 and the replaceable head 34.

In the embodiments described above, the shape of the replaceable head is not limited to a cylinder and may be designed as a rectangular column or other prisms, and the shape of the conductive tube or rod may vary accordingly for being combined with the replaceable head in a contact manner.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A pen for capacitive touch input, comprising:
a plurality of replaceable heads; and
a conductive tube receiving the plurality of replaceable heads and exposing a conductive tip of a foremost one of the plurality of replaceable heads.

2. The pen of claim 1, wherein each of the plurality of replaceable heads has a tail end with a stocking hole for receiving the conductive tip of another of the plurality of replaceable heads.

3. The pen of claim 1, wherein each of the plurality of replaceable heads is peripherally provided with resilient projections for contacting with an inner wall of the conductive tube.

4. The pen of claim 1, further comprising a tail cap covering a tail end of the conductive tube.

5. The pen of claim 1, wherein each of the plurality of replaceable heads comprises a rubber containing a conductive substance.

6. The pen of claim 5, wherein the conductive substance comprises carbon powder or metal powder.

7. The pen of claim 1, wherein the conductive tube is made of a conductive metal.

8. The pen of claim 1, wherein the conductive tube is made of a plated plastic.

9. A pen for capacitive touch input, comprising:
a replaceable head; and
a conductive rod having a front end with a stocking hole holding the replaceable head and exposing a conductive tip of the replaceable head.

10. The pen of claim 9, wherein the replaceable head is peripherally provided with resilient projections for contacting with an inner wall of the stocking hole when the replaceable head and the conductive rod are combined with each other.

11. The pen of claim 9, wherein the stocking hole and the replaceable head comprise a combination of a magnetic element and a magnetizable element for the replaceable head to be secured in the stocking hole by magnetic attraction.

12. The pen of claim 11, wherein the magnetizable element is made of a magnetizable metal.

13. The pen of claim 12, wherein the magnetizable metal is iron.

14. The pen of claim 9, wherein the replaceable head comprises a rubber containing a conductive substance.

15. The pen of claim 14, wherein the conductive substance comprises carbon powder or metal powder.

16. The pen of claim 9, wherein the conductive rod is made of a conductive metal.

17. The pen of claim 9, wherein the conductive rod is made of a plated plastic.

18. The pen of claim 9, wherein the replaceable head comprises a central post and a rubber containing a conductive substance, combined together by a co-molding process.
